(19) United States
(12) Patent Application Publication
(10) Pub. No.: US 2025/0229617 A1
(43) Pub. Date: Jul. 17, 2025

(54) ELECTRIC VEHICLE STRUCTURE

(71) Applicants: Hyundai Motor Company, Seoul (KR); Kia Corporation, Seoul (KR)

(72) Inventors: Won Hae LEE, Seoul (KR); Seung Hak LEE, Asan-Si (KR); Chang Kyu KIM, Hwaseong-Si (KR); Mi Ran PARK, Hwaseong-Si (KR); Byung Joo CHUNG, Gunpo-Si (KR); Jung Ju KIM, Seoul (KR); Nam Ho KIM, Gwangmyeong-Si (KR)

(21) Appl. No.: 18/805,876

(22) Filed: Aug. 15, 2024

(30) Foreign Application Priority Data
Jan. 11, 2024 (KR) 10-2024-0005059

(51) Int. Cl. B60K 1/04; B60K 1/00; B62D 25/20

(52) U.S. Cl. CPC B60K 1/04; B62D 25/2072; B60K 2001/005; B60K 2001/0438

(57) ABSTRACT

An electric vehicle structure includes a chassis frame in which a closed curve surrounding a battery accommodating space is formed, a water-tight panel formed so that another closed curve surrounding an internal side of the closed curve that surrounds the battery accommodating space of the chassis frame is formed, an upper cover coupled to an upper portion of the water-tight panel to cover an upper portion of the battery accommodating space, and an under cover coupled to a lower portion of the water-tight panel to cover a lower portion of the battery accommodating space.

### CROSS REFERENCE TO RELATED APPLICATIONS

The present application claims priority to Korean Patent Application No. 10-2024-0005059, filed Jan. 11, 2024, the entire contents of which is incorporated herein for all purposes by this reference.

### BACKGROUND OF THE PRESENT DISCLOSURE

### Field of the Present Disclosure

The present disclosure relates to an electric vehicle structure.

### Description of Related Art

An electric vehicle generates driving power of the vehicle by a motor, and a battery is mounted in the electric vehicle so that an electric power provided to the motor is stably supplied.

Generally, a battery in the form of a battery pack is mounted in the vehicle, the battery pack is configured in a form in which a plurality of battery modules is accommodated in a pack case, and the battery module has a form in which a plurality of battery cells is overlapped.

The battery pack as described above generally has a configuration separately mounted on a lower portion of a vehicle body.

Meanwhile, since a driving distance of an electric vehicle is significantly influenced by the amount of battery modules mounted in the vehicle, a large amount of battery modules is required to be mounted in the vehicle as much as possible.

Furthermore, the battery module mounted in the vehicle is required to be accommodated in a water-tight space which is configured to prevent foreign substances such as moisture and the like from penetrating the battery module.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electric vehicle structure capable of reducing a weight of a vehicle and realizing efficient space utilization, the electric vehicle structure being capable of effectively increasing a driving distance of the vehicle by maximizing the amount of a battery module, and the electric vehicle structure being capable of reliably securing a water-tightness of a space in which the battery module is accommodated with a relatively simple configuration.

To achieve the objectives of the present disclosure, there is provided an electric vehicle structure including: a chassis frame including a closed curve that surrounds a battery accommodating space; and a water-tight panel formed so that another closed curve surrounding an internal side of the closed curve which surrounds the battery accommodating space of the chassis frame is formed, wherein the water-tight panel is formed so that an inclined wall that extends along an internal surface of the chassis frame forms a smooth closed curve, an internal wall of the chassis frame facing the water-tight panel is formed as a vertical wall surface, a mounting protrusion portion that locally protrudes so that the mounting protrusion portion is capable of being in surface-contact with the inclined wall of the water-tight panel is provided on the internal wall which is formed as the vertical wall surface, a plurality of internal members traversing inside the battery accommodating space is mounted inside the water-tight panel, and the mounting protrusion portion is formed so that the mounting protrusion portion faces an end portion of the internal member, so that a portion where the internal member and the mounting protrusion portion match each other is welded and joined.

The electric vehicle structure may further include an under cover coupled to a lower portion of the water-tight panel, covering a lower portion of the battery accommodating space.

The closed curve surrounding the battery accommodating space of the chassis frame may be formed by: a center side member provided in front and rear directions of the vehicle on first and second sides of the chassis frame; and a front cross member and a rear cross member which are provided in a transverse direction of the vehicle to connect the center side members at both the sides to each other and which are spaced from each other in the front and rear directions of the vehicle.

The water-tight panel may be formed so that an inclined wall that extends along internal surfaces of the center side member, the front cross member, and the rear cross member forms a smooth closed curve.

The inclined wall of the water-tight panel may be formed so that the inclined wall is inclined toward an internal side of the battery accommodating space from an upper side of the inclined wall to a lower side of the inclined wall.

The water-tight panel may be provided with a flange portion that extends toward a horizontal direction on at least one of an upper end portion and a lower end portion of the inclined wall.

At least one of the center side member, the front cross member, and the rear cross member may be formed so that at least one internal wall of the center side member, the front cross member, and the rear cross member facing the water-tight panel is formed as a vertical wall surface.

A welding flange may be formed on the end portion of the internal member by being bent in a direction parallel to a plane of the mounting protrusion portion, and the welding flange may be welded while being in a state in which the welding flange is in surface-contact with the water-tight panel.

The end portion of the internal member, the water-tight panel, and the mounting protrusion portion may be welded in a triplex manner.

The electric vehicle structure may further include an upper cover coupled to an upper portion of the water-tight panel, covering an upper portion of the battery accommodating space.

According to another configuration of the present disclosure, there is provided an electric vehicle structure including: a side member forming first and second sides of a chassis frame; a plurality of cross members connecting each side member at the first and second sides; and a water-tight panel inserted into a closed curve formed by the side member and the cross members, the water-tight panel forming a closed curved surface having a predetermined width in a vertical direction and having a water-tightness, wherein the water-tight panel is formed so that an inclined wall that extends along internal surfaces of the side member and the cross members forms a smooth closed curve, internal walls of the side member and the cross members facing the water-tight panel are formed as vertical wall surfaces, a mounting protrusion portion that locally protrudes so that the mounting protrusion portion is capable of being in surface-contact with the inclined wall of the water-tight panel is provided on the internal walls formed as the vertical wall surfaces, a plurality of internal members traversing inside the battery accommodating space is mounted inside the water-tight panel, and the mounting protrusion portion is formed so that the mounting protrusion portion faces an end portion of the internal member, so that a portion where the internal member and the mounting protrusion portion match each other is welded and joined.

The closed curve of the chassis frame may be formed by a center side member positioned between a front side member and a rear side member of the side member, a front cross member connecting both front side end portions of the center side member, and a rear cross member connecting both rear side end portions of the center side member.

The closed curved surface having the predetermined width in the vertical direction of the water-tight panel may be formed by the inclined wall which is inclined toward an internal side of the battery accommodating space from an upper side of the inclined wall to a lower side of the inclined wall.

A flange portion that smoothly extends toward a horizontal direction may be provided on an upper end portion of the inclined wall of the water-tight panel.

An under cover that surrounds a lower side of the battery accommodating space may be provided on a lower side of the water-tight panel.

A cooling panel that surrounds a lower side of the battery accommodating space may be provided on the lower side of the inclined wall of the water-tight panel, and an under cover that surrounds a lower side of the cooling panel may be provided on the lower side of the cooling panel.

A bottom portion which extends on a lower end portion of the inclined wall and which seals a lower side of the battery accommodating space may be formed integrally with the water-tight panel.

A welding flange may be formed on the end portion of the internal member by being bent in a direction parallel to a plane of the mounting protrusion portion, and the welding flange may be welded while being in a state in which the welding flange is in surface-contact with the water-tight panel.

The end portion of the internal member, the water-tight panel, and the mounting protrusion portion may be welded in a triplex manner.

The electric vehicle structure may further include an upper cover mounted so that the upper cover surrounds an upper side of a battery accommodating space which is surrounded by the closed curved surface formed by the water-tight panel.

In an exemplary embodiment of the present disclosure, the weight of the vehicle is capable of reduced and the efficient space utilization is capable of being realized, the driving distance of the vehicle is capable of being effectively increased by maximizing the amount of the battery module, and the water-tightness of a space in which the battery module is accommodated is capable of being reliably secured with the relatively simple configuration.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an electric vehicle structure according to an exemplary embodiment of the present disclosure;

FIG. 2 is a plan view of FIG. 1;

FIG. 3 is a bottom view of FIG. 1;

FIG. 4 is a view exemplarily illustrating a water-tight panel in FIG. 1;

FIG. 5 is a detailed local view of FIG. 1, illustrating a state in which the water-tight panel is omitted;

FIG. 6 is a view exemplarily illustrating a mounting protrusion portion formed on a center side member;

FIG. 7 is a cross-sectional view taken along line VII-VII in FIG. 5;

FIG. 8 is a cross-sectional view taken along line VIII-VIII in FIG. 5; and

FIG. 9 is a view exemplarily illustrating another exemplary embodiment of the water-tight panel.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. In the present specification, the same or similar components will be denoted by the same or similar reference numerals, and a repeated description thereof will be omitted.

In the following description, the expressions “module” and “portion” contained in terms of constituent elements to be described will be selected or used together in consideration only of the convenience of writing the following specification, and the expressions “module” and “portion” do not necessarily have different meanings or roles.

Detailed description of known technologies will be omitted if it is determined that the detailed description of the known technologies obscures the exemplary embodiments of the present specification. Furthermore, the accompanying drawings are merely intended to easily describe the exemplary embodiments of the present specification, but the spirit and technical scope of the present specification is not limited by the accompanying drawings. It should be understood that the present specification is not limited to predetermined disclosed exemplary embodiments of the present disclosure, but includes all modifications, equivalents and substitutes included within the spirit and technical scope of the present disclosure.

Terms including ordinals such as “first” or “second” used herein may be used to describe various elements, but the elements are not limited by the terms. The terms are used only for distinguishing one constituent element from another constituent element.

When a component is referred to as being “connected” or “contacted” to another component, it should be understood that it may be directly connected or contacted to the other component, but other components may exist therebetween. On the other hand, when a component is referred to as being “directly connected” or “directly contacted” to another component, it should be understood that there is no other component therebetween.

Singular expressions include plural expressions unless the context clearly indicates otherwise.

It is to be understood that terms such as “including”, “having”, and the like are intended to indicate the existence of the features, numbers, steps, actions, elements, components, or combinations thereof included in the specification, and are not intended to preclude the possibility that one or more other features, numbers, steps, actions, elements, components, or combinations thereof may exist or may be added.

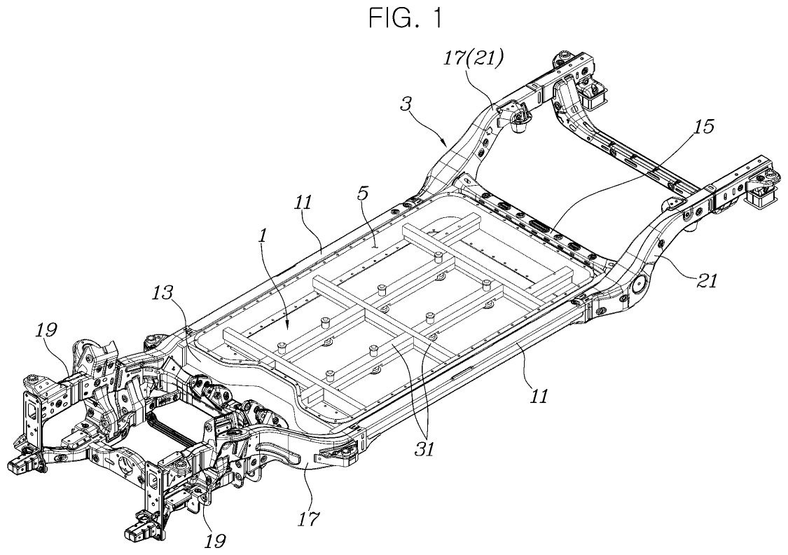

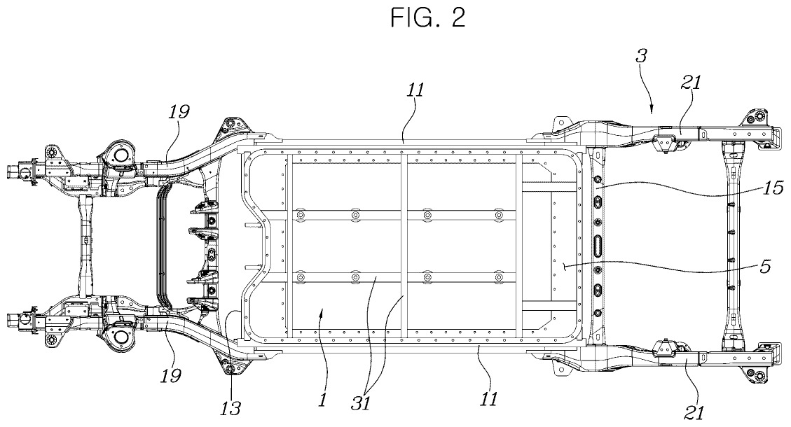

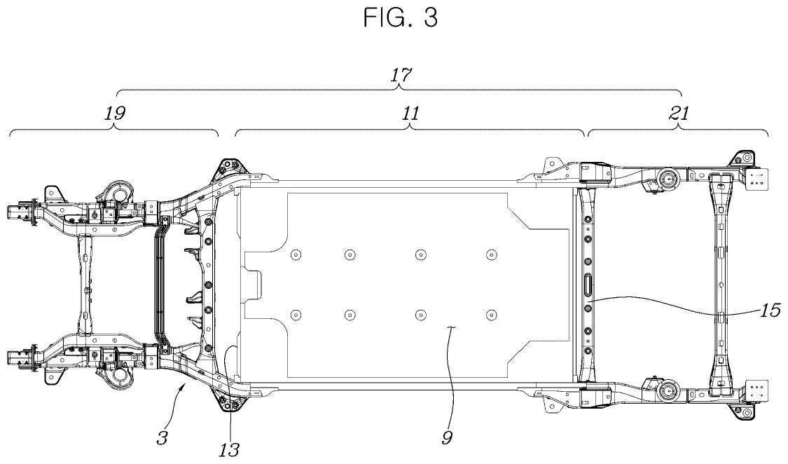

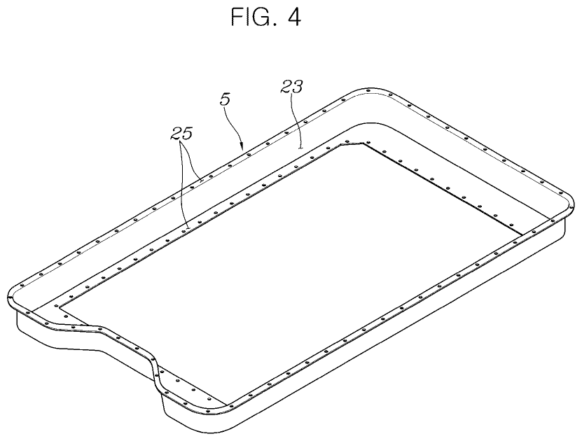

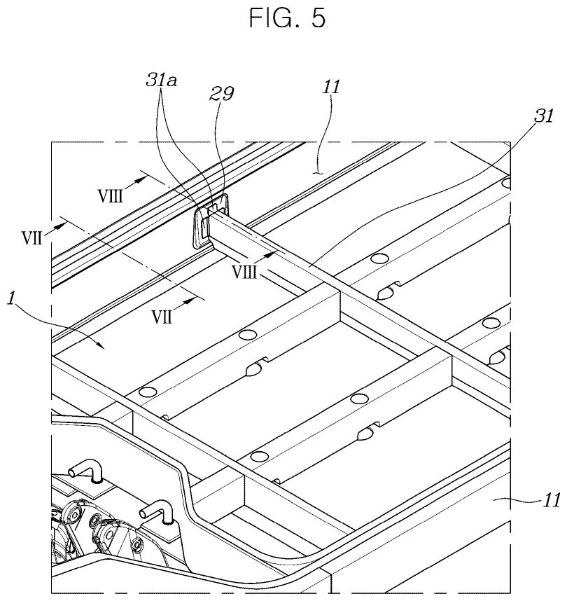

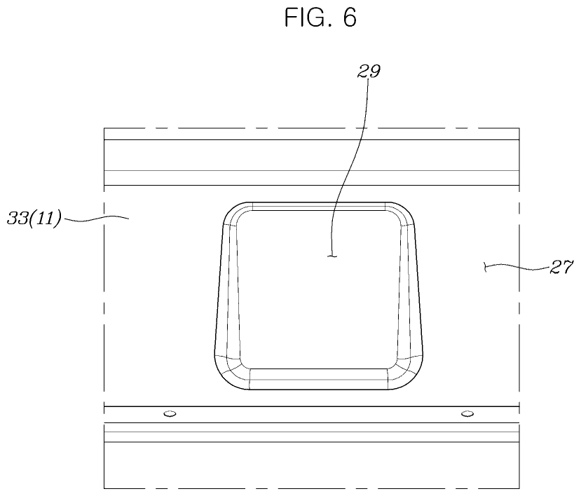

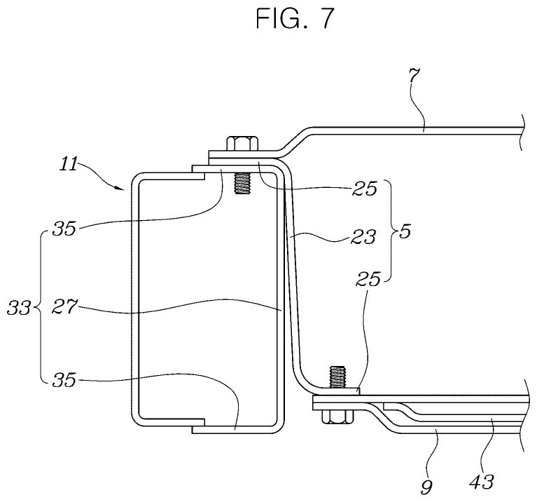

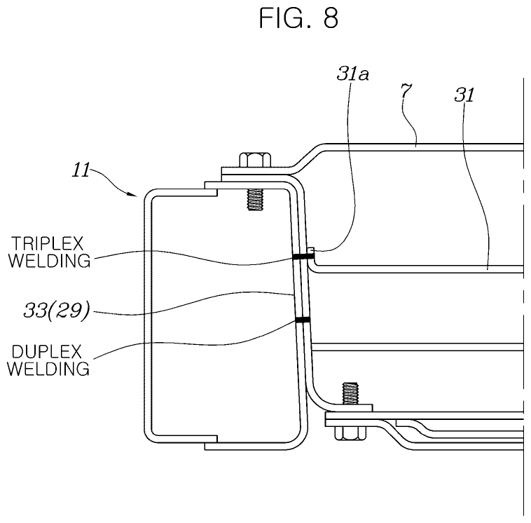

Referring to FIG. 1, FIG. 2, FIG. 3, FIG. 4, FIG. 5, FIG. 6, FIG. 7, and FIG. 8, an exemplary embodiment of an electric vehicle structure of the present disclosure includes: a chassis frame 3 in which a closed curve surrounding a battery accommodating space 1 is formed; a water-tight panel 5 formed so that another closed curve surrounding an internal side of the closed curve that surrounds the battery accommodating space 1 of the chassis frame 3 is formed; an upper cover 7 coupled to an upper portion of the water-tight panel 5, covering an upper portion of the battery accommodating space 1; and an under cover 9 coupled to a lower portion of the water-tight panel 5, covering a lower portion of the battery accommodating space 1.

That is, in the electric vehicle structure of the present disclosure, the battery accommodating space 1 is formed in the closed curve formed in the chassis frame 3. Therefore, compared to a conventional method in which a separate battery pack is mounted in a vehicle body, the electric vehicle structure of the present disclosure is configured so that a weight of a vehicle is capable of being reduced, an efficient space utilization is capable of being realized, and also a driving distance of the vehicle is effectively increased by maximizing the amount of a battery module to be mounted.

Furthermore, because the battery accommodating space 1 is effectively sealed by use of the water-tight panel 5, the upper cover 7, and the under cover 9, the water-tightness of the battery accommodating space 1 is reliably secured by a simple configuration.

Here, the closed curve surrounding the battery accommodating space 1 of the chassis frame 3 may be formed by: each center side member 11 provided long in front and rear directions of the vehicle on both sides of the chassis frame 3; and a front cross member 13 and a rear cross member 15 which are provided long in a transverse direction of the vehicle to connect the center side members 11 at both the sides thereof to each other and which are spaced from each other in the front and rear directions of the vehicle.

In the chassis frame 3, each side member 17 is provided long in the front and rear directions of the vehicle on both the sides of the chassis frame 3, and the plurality of cross members provided long in the transverse direction of the vehicle is mounted between each side member 17 to connect the side members 17 to each other.

The side member 17 includes a structure in which a front side member 19 forming a front side of the vehicle and a rear side member 21 forming a rear side of the vehicle are respectively connected to a front side and a rear side of the center side members 11 that are connecting the front side member 19 and the rear side member 21 to each other.

The front cross member 13 is mounted so that the front sides of each center side member 11 are connected to each other, and the rear cross member 15 is mounted so that the rear sides of each center side member 11 are connected to each other.

That is, in an exemplary embodiment of the present disclosure, the closed curve forming the battery accommodating space 1 which is surrounded by the chassis frame 3 is formed by the center side member 11, the front cross member 13, and the rear cross member 15. Therefore, many battery modules are capable of being mounted as possible in the battery accommodating space 1, but the space at upper and lower sides of the chassis frame 3 is not occupied, so that space utilization of the vehicle is capable of being ultimately maximized and the weight of the vehicle is capable of being reduced.

The water-tight panel 5 is formed so that an inclined wall 23 that extends along internal surfaces of the center side member 11, the front cross member 13, and the rear cross member 15 forms a smooth closed curve.

The inclined wall 23 of the water-tight panel 5 is formed so that the inclined wall 23 is inclined toward an internal side of the battery accommodating space 1 from an upper side of the inclined wall 23 to a lower side of the inclined wall 23.

That is, the water-tight panel 5 is integrally formed by deep drawing, so that the inclined wall 23 as described above may be formed in a shape that forms one closed curve.

The center side member 11, the front cross member 13, and the rear cross member 15 serve mainly to provide structural rigidity of the vehicle, are mainly formed of a steel material formed by a press process, and are coupled to each other by welding or the like.

Furthermore, because it is difficult to secure consistency of shapes and constant flatness of coupling portions of the center side member 11, the front cross member 13, and the rear cross member 15, it is difficult to provide complete water-tightness to the battery accommodating space 1 when the center side member 11, the front cross member 13, and the rear cross member 15 are coupled to the upper cover 7 and the under cover 9.

In an exemplary embodiment of the present disclosure, in such a situation, the continuous surface of the inclined wall 23 of the water-tight panel 5 surrounds the internal side of the closed curve formed by the center side member 11, the front cross member 13, and the rear cross member 15, so that the complete water-tightness of the battery accommodating space 1 is easily secured.

Even in a situation in which a torsion of the chassis frame 3 occurs, in a configuration using the water-tight panel 5, the water-tightness of the battery accommodating space 1 may be more solidly maintained.

Meanwhile, the water-tight panel 5 may be provided with a flange portion 25 that smoothly extends toward a horizontal direction on at least one of an upper end portion and a lower end portion of the inclined wall 23.

Such a flange portion 25 may significantly increase the coupling between the water-tight panel 5 and the upper cover 7 or between the water-tight panel 5 and the under cover 9, so that the complete water-tightness may be easily secured.

For reference, FIG. 7 and FIG. 8 are examples in which the flange portion 25 is provided at both the upper end portion and the lower end portion of the inclined wall 23. Furthermore, although not illustrated in the drawings, the flange portion 25 may be provided only at the upper end portion of the inclined wall 23, or the flange portion 25 may be provided only at the lower end portion of the inclined wall 23.

At least one of the center side member 11, the front cross member 13, and the rear cross member 15 may be formed so that an internal wall 27 facing the water-tight panel 5 is formed as a vertical wall surface, and a mounting protrusion portion 29 that locally protrudes so that the mounting protrusion portion 29 is in surface-contact with the inclined wall 23 of the water-tight panel 5 may be provided on the internal wall 27 which is formed as the vertical wall surface.

The water-tight panel 5 is required to be coupled to the center side member 11, the front cross member 13, and the rear cross member 15. To the present end, the mounting protrusion portion 29 is provided and a surface-contact region between the mounting protrusion portion 29 and the water-tight panel 5 is coupled by welding or the like.

In an exemplary embodiment of the present disclosure, as illustrated in FIGS. 5 to 8, the mounting protrusion portion 29 is provided locally on the internal wall 27 of the center side member 11, and the inclined wall 23 of the water-tight panel 5 which is in surface-contact with the mounting protrusion portion 29 is coupled to the mounting protrusion portion 29 by welding or the like.

A plurality of internal members 31 traversing the inside of the battery accommodating space 1 is provided inside the water-tight panel 5, and the mounting protrusion portion 29 is formed so that the mounting protrusion portion 29 faces an end portion of the internal member 31 and a portion where the internal member 31 and the mounting protrusion portion 29 match each other is welded and joined.

Furthermore, a welding flange 31a may be formed on the end portion of the internal member 31 by being bent in a direction parallel to a plane of the mounting protrusion portion 29, and the welding flange 31a may be welded while being in a state in which the welding flange 31a is in surface-contact with the water-tight panel 5.

At the present time, the end portion of the internal member 31, the water-tight panel 5, and the mounting protrusion portion 29 may be welded in a triplex manner.

In FIG. 5, it is illustrated in the drawing that the water-tight panel 5 is omitted, and a state in which the end portion of the internal member 31 is aligned so that the end portion of the internal member 31 faces the mounting protrusion portion 29 of the center side member 11.

As described above, when the internal members 31 inside the water-tight panel 5 are disposed so that the internal members 31 face each other with the water-tight panel 5 interposed therebetween, the mounting protrusion portion 29 and the internal members 31 form a solid load path against an impact force and the like input through the center side member 11 from a side of the vehicle, so that a deformation of the battery accommodating space 1 is suppressed, being capable of realizing more safe protection of the accommodated battery module.

The welding flange 31a having a shape bent outwardly extends on the end portion of the internal member 31 facing the mounting protrusion portion 29, and the welding flange 31a is in surface-contact with the internal surface of the water-tight panel 5.

Accordingly, three panels, which are the welding flange 31a of the internal member 31, the water-tight panel 5, and the mounting protrusion portion 29, overlap. In the instant state, spot welding is performed, realizing triplex welding.

For reference, in a portion where only the water-tight panel 5 and the mounting protrusion portion 29 overlap, the two panels are welded and joined by spot welding.

Meanwhile, the internal wall 27 of the center side member 11 may be formed so that the internal wall 27 of the center side member 11 includes the same inclination as the inclined wall 23 of the water-tight panel 5. However, in the instant case, in the press process for forming the internal member 33 provided with the internal wall 27 of the center side member 11, side effects such as causing an undercut or having a difficult workability may occur.

That is, in a press mold for forming the internal member 33 in which the internal wall 27 of the center side member 11 is formed in parallel to the inclined wall 23 of the water-tight panel 5, when a portion of the internal wall 27 is formed as a cavity in a horizontal direction, the undercut may occur on a lower wing portion 35 of the two wing portions 35 that are connected to each other via upper and lower portions of the internal wall 27. Furthermore, when the internal wall 27 is formed as an inclined cavity, a defect rate may increase during press work due to the difference in length between the two wing portions 35.

That is, as described above in an exemplary embodiment of the present disclosure, the internal wall 27 of the center side member 11 generally includes a vertical wall shape, but the mounting protrusion portion 29 protrudes locally, so that side effects which may occur in the press process as described above may be prevented and the excellent coupling between the mounting protrusion portion 29 and the water-tight panel 5 may be secured.

Furthermore, in the configuration described above, welding gas generated during welding work of the water-tight panel 5 and the mounting protrusion portion 29 is easily discharged to a gap between the water-tight panel 5 and the mounting protrusion portion 29, and a paint solution easily penetrates into a space between the center side member 11 and the water-tight panel 5, so that easier and more reliable painting may be realized, being capable of improving a rust prevention performance of the chassis frame 5 and the water-tight panel 5.

Furthermore, when the internal wall 27 of the center side member 11 is formed so that the internal wall 27 is inclined at an angle equal to the inclined wall 23 of the water-tight panel 5, the plane management is required to be performed on a substantially wide surface, so that manufacturability may be reduced compared to manufacturability in a situation when the mounting protrusion portion 29 is provided only locally so that a surface-contact state with the water-tight panel 5. However, as described above, because the mounting protrusion portion 29 is formed so that the mounting protrusion portion 29 is formed only locally on the center side member 11 as described above, manufacturability of the vehicle may be increased.

The present disclosure as described above may be expressed as follows.

That is, in an exemplary embodiment of the electric vehicle structure of the present disclosure, the electric vehicle structure includes: the side member forming both the sides of the chassis frame; the plurality of cross members connecting each side member at both the sides; the water-tight panel inserted into the closed curve formed by each side member and the cross members, the water-tight panel forming the closed curved surface having the predetermined width in the vertical direction and having the water-tightness; and the upper cover mounted so that the upper cover surrounds the upper side of the battery accommodating space which is surrounded by the closed curved surface formed by the water-tight panel. Furthermore, the water-tight panel is formed so that the inclined wall that extends along the internal surface of the side member and the internal surface of the cross member forms the smooth closed curve, the internal wall of the side member and the internal wall of the cross member are formed as vertical wall surfaces, the internal walls formed as the vertical wall surfaces are provided with the mounting protrusion portion that locally protrudes so that the mounting protrusion portion is capable of being in surface-contact with the inclined wall of the water-tight panel, the plurality of internal members traversing inside the battery accommodating space is mounted inside the water-tight panel, and the mounting protrusion portion is formed so that the mounting protrusion portion faces the end portion of the internal member so that the portion where the internal member and the mounting protrusion portion match each other is capable of being welded and joined.

The closed curve of the chassis frame 3 may be formed by the center side member 11 positioned between the front side member 19 and the rear side member 21 of the side member 17, the front cross member 13 connecting both front side end portions of the center side member 11, and a rear cross member 15 connecting both rear side end portions of the center side member 11.

The closed curved surface having the predetermined width in the vertical direction of the water-tight panel 5 may be formed by the inclined wall 23 which is inclined toward the internal side of the battery accommodating space 1 from an upper side of the inclined wall 23 to a lower side of the inclined wall 23.

The flange portion 25 that smoothly extends toward the horizontal direction may be provided on the upper end portion of the inclined wall 23 of the water-tight panel 5.

As illustrated in FIG. 7 or FIG. 8, the under cover 9 that surrounds the lower side of the battery accommodating space 1 may be provided on the lower side of the water-tight panel 5.

Furthermore, a cooling panel 43 that surrounds the lower side of the battery accommodating space 1 may be provided on the lower side of the inclined wall 23 of the water-tight panel 5, and the under cover 9 that surrounds a lower side of the cooling panel 43 may be provided on the lower side of the cooling panel 43.

A flow path is formed in the cooling panel 43, and refrigerant flows through the flow path, so that cooling of the battery module accommodated in the battery accommodating space 1 may be effectively realized.

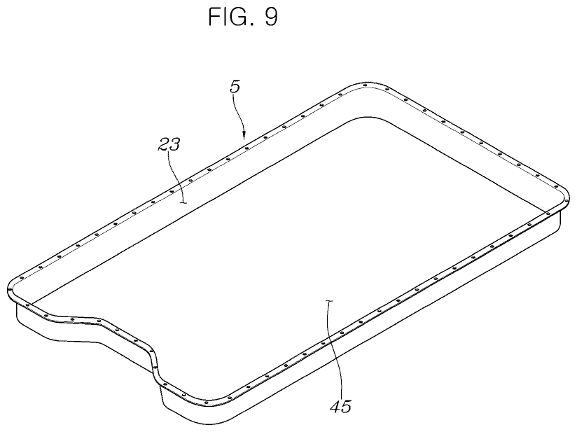

Meanwhile, as illustrated in FIG. 9, a bottom portion 45 which extends on the lower end portion of the inclined wall 23 and which seals the lower side of the battery accommodating space 1 may be formed integrally with the water-tight panel 5.

The welding flange 31a may be formed on the end portion of the internal member 31 by being bent in the direction parallel to the plane of the mounting protrusion portion 29, and the welding flange 31a may be welded while being in a state in which the welding flange 31a is in surface-contact with the water-tight panel 5.

The end portion of the internal member 31, the water-tight panel 5, and the mounting protrusion portion 29 may be welded in a triplex manner.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electric vehicle structure comprising:
a chassis frame including a closed curve that surrounds a battery accommodating space; and
a water-tight panel including another closed curve surrounding an internal side of the closed curve which surrounds the battery accommodating space of the chassis frame,
wherein the water-tight panel includes an inclined wall that extends along an internal surface of the chassis frame and forms a closed curve,
wherein an internal wall of the chassis frame facing the water-tight panel is formed as a vertical wall surface,
wherein the internal wall which is formed as the vertical wall surface includes a mounting protrusion portion that locally protrudes so that the mounting protrusion portion is capable of being in surface-contact with the inclined wall of the water-tight panel,
wherein a plurality of internal members traversing inside the battery accommodating space is mounted inside the water-tight panel, and
wherein the mounting protrusion portion faces an end portion of the internal members, so that a portion where the internal members and the mounting protrusion portion match each other is welded and joined.

2. The electric vehicle structure of claim 1, further including an under cover coupled to a lower portion of the water-tight panel and covering a lower portion of the battery accommodating space.

3. The electric vehicle structure of claim 1, further including:
a center side member, a front cross member and a rear cross member,
wherein the closed curve surrounding the battery accommodating space of the chassis frame is formed by:
the center side member provided in front and rear directions of a vehicle on first and second sides of the chassis frame; and
the front cross member and the rear cross member which are provided in a transverse direction of the vehicle to connect the center side member at the first and second sides to each other and which are spaced from each other in the front and rear directions of the vehicle.

4. The electric vehicle structure of claim 3, wherein the water-tight panel includes the inclined wall that extends along internal surfaces of the center side member, the front cross member, and the rear cross member forms the closed curve.

5. The electric vehicle structure of claim 4, wherein the inclined wall is inclined toward an internal side of the battery accommodating space from an upper side of the inclined wall to a lower side of the inclined wall.

6. The electric vehicle structure of claim 5, wherein the water-tight panel includes a flange portion that extends toward a horizontal direction on at least one of an upper end portion and a lower end portion of the inclined wall.

7. The electric vehicle structure of claim 5, wherein at least one internal wall of the center side member, the front cross member, and the rear cross member facing the water-tight panel is formed as a vertical wall surface.

8. The electric vehicle structure of claim 1,
wherein the end portion of the internal member includes a welding flange bent in a direction parallel to a plane of the mounting protrusion portion, and the welding flange is welded while being in a state in which the welding flange is in surface-contact with the water-tight panel.

9. The electric vehicle structure of claim 8, wherein the end portion of the internal member, the water-tight panel, and the mounting protrusion portion are welded in a triplex manner.

10. The electric vehicle structure of claim 1, further including an upper cover coupled to an upper portion of the water-tight panel, and covering an upper portion of the battery accommodating space.

11. An electric vehicle structure comprising:
a side member forming first and second sides of a chassis frame;
a plurality of cross members connecting each side member at the first and second sides of the chassis frame; and
a water-tight panel inserted into a closed curve formed by the side member and the cross members, the water-tight panel forming a closed curved surface having a predetermined width in a vertical direction and having a water-tightness,
wherein the water-tight panel includes an inclined wall that extends along internal surfaces of the side member and the cross members and forms a closed curve,
wherein inner walls of the side member and the cross members facing the water-tight panel are formed as vertical wall surfaces,
wherein the internal walls formed as the vertical wall surfaces includes a mounting protrusion portion that locally protrudes so that the mounting protrusion portion is capable of being in surface-contact with the inclined wall of the water-tight panel,
wherein a plurality of internal members traversing inside a battery accommodating space is mounted inside the water-tight panel, and
wherein the mounting protrusion portion faces an end portion of the internal members, so that a portion where the internal members and the mounting protrusion portion match each other is welded and joined.

12. The electric vehicle structure of claim 11, further including:
a center side member, a front cross member and a rear cross member,
wherein the closed curve of the chassis frame is formed by the center side member positioned between a front side member and a rear side member of the side member, the front cross member connecting both front side end portions of the center side member, and the rear cross member connecting both rear side end portions of the center side member.

13. The electric vehicle structure of claim 12, wherein the closed curved surface having the predetermined width in the vertical direction of the water-tight panel is formed by the inclined wall which is inclined toward an internal side of the battery accommodating space from an upper side of the inclined wall to a lower side of the inclined wall.

14. The electric vehicle structure of claim 13, wherein an upper end portion of the inclined wall of the water-tight panel includes a flange portion that extends toward a horizontal direction.

15. The electric vehicle structure of claim 13, further including an under cover that is mounted on a lower side of the water-tight panel and surrounds a lower side of the battery accommodating space.

16. The electric vehicle structure of claim 13, further including:
a cooling panel that is mounted on the lower side of the inclined wall of the water-tight panel and surrounds a lower side of the battery accommodating space; and
an under cover that is mounted on the lower side of the cooling panel and surrounds a lower side of the cooling panel.

17. The electric vehicle structure of claim 13, wherein a bottom portion which extends on a lower end portion of the inclined wall and which seals a lower side of the battery accommodating space is formed integrally with the water-tight panel.

18. The electric vehicle structure of claim 11, wherein the end portion of the internal member includes a welding flange bent in a direction parallel to a plane of the mounting protrusion portion, and the welding flange is welded while being in a state in which the welding flange is in surface-contact with the water-tight panel.

19. The electric vehicle structure of claim 18, wherein the end portion of the internal member, the water-tight panel, and the mounting protrusion portion are welded in a triplex manner.

20. The electric vehicle structure of claim 11, further including an upper cover surrounding an upper side of the battery accommodating space which is surrounded by the closed curved surface formed by the water-tight panel.
